(19) United States
(12) Patent Application Publication
(10) Pub. No.: US 2013/0031836 A1
(43) Pub. Date: Feb. 7, 2013

(54) Planting Device

(71) Applicant: Thomas Schaefer, Kewanee, IL (US)

(72) Inventor: Thomas Schaefer, Kewanee, IL (US)

(21) Appl. No.: 13/136,530

(22) Filed: Aug. 3, 2011

(51) Int. Cl. A01G 9/02

(52) U.S. Cl. 47/81

(57) ABSTRACT

The present invention is a planting device design for multiple plant containers. Said planting device incorporates a reservoir and a wick for each plant container. When placing the plant container through the lid, a flap is opened. Said flap positions the plant container so that the wick is in contact with the water, but the container containing the soil is not in contact with the water. This reduces the possibility of rot. Said flap also closes when the plant container is removed thereby preventing pollutants (e.g. insects, leaves) along with pets or light from communicating with the water.

### CROSS-REFERENCE TO RELATED APPLICATIONS

Not Applicable

SEARCH: A search was conducted in the U.S. Art Class 47, Subclasses 71, 79, 80 and 81.

### REFERENCES (U.S. PATENTS)

| | | |
|---|---|---|
| 320,588 | (Rhoads) | Jun. 23, 1885 |
| 1,216,642 | (White) | Feb. 20, 1917 |
| 1,247,766 | (White) | Nov. 27, 1917 |
| 3,898,766 | (Goldstaub) | Aug. 12, 1975 |
| 4,083,146 | (Brankovic) | Apr. 11, 1978 |
| 4,236,352 | (Heaney) | Dec. 21, 1980 |
| 4,339,891 | (Bassett) | Jul. 20, 1982 |
| 4,829,709 | (Centafanti) | May 16, 1989 |
| 4,996,792 | (Holtkamp, Sr.) | Mar. 05, 1991 |
| 5,111,614 | (Holtkamp, Sr.) | May 12, 1992 |
| 5,136,806 | (Kang) | Aug. 11, 1992 |
| 5,491,929 | (Peacock) | Feb. 20, 1996 |
| 5,535,542 | (Gardner) | Jul. 16, 1996 |
| 5,860,249 | (Holtkamp, Jr.) | Jan. 19, 1999 |
| 2004/0237403 | (Sekiya) | Dec. 08, 2004 |
| 2005/0229487 | (Whisenant) | Oct. 20, 2005 |
| 2006/0112634 | (Vogt) | Jun. 01, 2006 |

### STATEMENT REGARDING FEDERALLY SPONSORED RESEARCH OR DEVELOPMENT

Not Applicable

### REFERENCE TO A “MICROFICHE APPENDIX”

### See 37 CFR 1.96

Not Applicable

### BACKGROUND OF THE INVENTION

1. Field of the Invention

This invention relates to a portable, multi-plant “house” for growing indoors or outside. Said invention incorporates wicks and a reservoir for uniform and continual watering and a unique lid to keep debris, pests and sunlight from the water reservoir.

2. Description of Related Art Including Information Disclosed Under 37 CFR 1.97 and 1.98

The Rhoads Patent (U.S. Pat. No. 320,588) is a flower pot with a wick resting on a reservoir filled with water.

The White Patent (U.S. Pat. No. 1,216,642) is a planter which sits on top of a reservoir. A sponge/tube combination is utilized as a wick.

The White Patent (U.S. Pat. No. 1,247,766) is similar to the above White Patent with the capacity to accommodate several plants.

The Goldstaub Patent (U.S. Pat. No. 3,898,766) is a planting device (with wicks) with a frame which rests in a reservoir of water.

The Brankovic (U.S. Pat. No. 4,083,146) is a planting device incorporating a wick. Said device incorporates a shell with apertures which shell is shaped similar to the plant container.

The Heaney Patent (U.S. Pat. No. 4,236,352) is a planting device with a wick system comprising a spongy material with means to constrict the spongy material thereby regulating the capillary effect of the wick.

The Bassett Patent (U.S. Pat. No. 4,339,891) is a support system for a plant device (“pot”) with a wick whereby the pot rests on top of the support system.

The Centafanti Patent (U.S. Pat. No. 4,829,709) is a planting device incorporating a wick and a reservoir whereby the pot sits on top the reservoir.

The Holtkamp, Sr. Patent (U.S. Pat. No. 4,996,792) is a planting device with a wick whereby the pot sits within a beveled (downwardly and inwardly) orifice in order to accommodate said pot.

The Holtkamp, Sr. Patent (U.S. Pat. No. 5,111,614) is similar to the above Holtkamp, Sr. Patent with the following changes: transparency is not an element, the bevel disposed on the orifice is omitted and the pot requires a flange.

The Kang Patent (U.S. Pat. No. 5,136,806) contains multiple claims encompassing the following: a pot where the bottom of the pot is elevated, said pot having a wick and resting in an open reservoir of water; or a pot where the bottom of the pot is elevated due to being wedged into an opening of an otherwise closed reservoir.

The Peacock Patent (U.S. Pat. No. 5,491,929) is a spill-proof planting device which incorporates a wick. The pot is placed inside of a re-entrant structure which is cone shaped and sloped inwardly and downwardly. The geometry of the reservoir makes it spill proof if turned on its side.

The Gardner Patent (U.S. Pat. No. 5,535,542) is a planting device which incorporates a wick and a reservoir which reservoir incorporates a hole or a plurality of holes to allow air flow over the water in the reservoir. The pots rest on a plate above the reservoir which plate has openings incorporated into the sides to maintain, and ventilate, the air space above the water level.

The Holtkamp, Jr. Patent (U.S. Pat. No. 5,860,249) is a spill-proof planting device similar to the Peacock Patent U.S. Pat. No. 5,491,929 with the additional virtue that the reservoir top and bottom halves can be dismantled without the need to remove the pot from the top half of the reservoir.

The Sekiya Patent (#2004/0237403) is a planting device with a reservoir and means to calibrate the amount of water being absorbed by the soil.

The Whisenant Patent (#2005/0229487) is a method which incorporates a planting device with a reservoir and makes efficient use of soil nutrients such as nitrogen and potassium. Claims are also made to the reservoir itself.

The Vogt Patent (#2006/0112634) is a planting device which incorporates a wick and a reservoir and fastening means to unite the top portion of the reservoir and the bottom portion of the reservoir. Said patent also claims an opening whereby water can be added to the reservoir.

### BRIEF SUMMARY OF THE INVENTION

The present invention is a planting device for multiple plants. Said planting device incorporates: multiple plant containers; a wick for each of said plant containers; a reservoir and a novel lid for holding said plant containers.

Said novel lid has a plurality “cuts” through the top surface thereby producing flaps which accommodate the insertion of a plant container partially through the lid.

This invention recognizes the need to cover the opening in the lid when a plant container is removed from the lid. When plant containers are absent from the planting device, said flaps automatically close and protect the fluid in the reservoir from light, pets, insects, leaves and other debris and pollutants.

### BRIEF DESCRIPTION OF THE SEVERAL VIEWS OF THE DRAWINGS

FIGURE ONE is a side view of a planting container with a wick.

FIGURE TWO is a top view of the plant container.

FIGURE THREE is an isometric view of the reservoir.

FIGURE FOUR is an isometric view of the lid.

FIGURE FIVE is a cross-sectional view of the preferred reservoir fastening means and the lid fastening means.

FIGURE SIX is an isometric view of flap and aperture.

FIGURE SEVEN is an isometric view of the dual-flap and aperture.

### DETAILED DESCRIPTION OF THE INVENTION

Referring to FIGS. ONE and TWO a wick 2 is tied into a knot 3 and inserted through the opening 7 in the plant container 1, such that the wick 2 is unable to pass all the way through the opening 7 because of the knot 3. Dirt 4 is placed into the plant container 1 so that the dirt covers the knot 3. A seed 5 is then planted in the dirt 4. Said plant container 1 has a lip 6 and sides 20 which are tapered so that to top 21 of said plant container 1 is larger than the bottom 22 of said plant container 1.

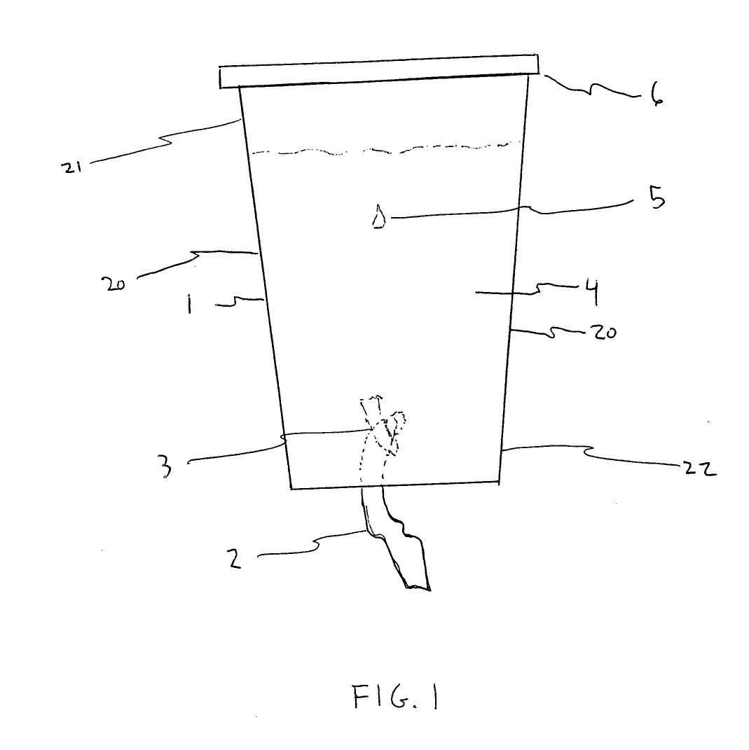

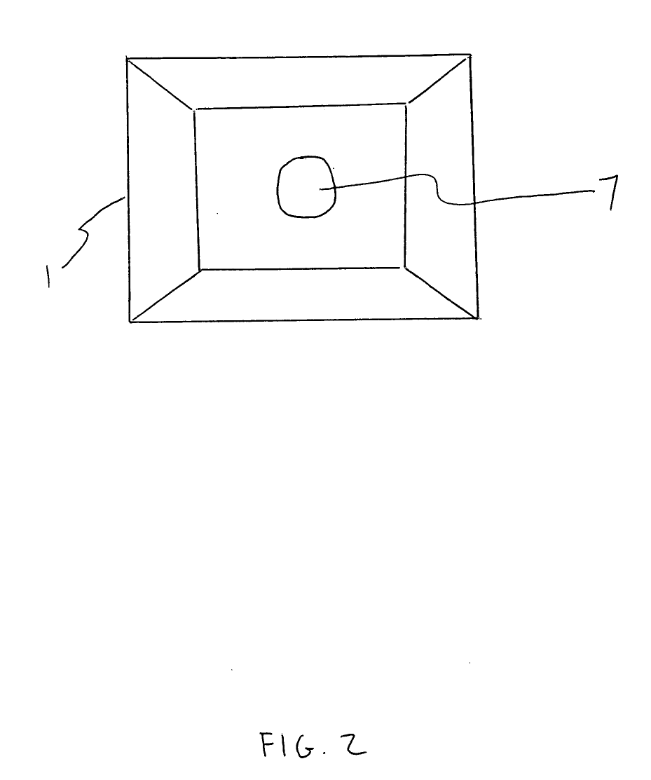

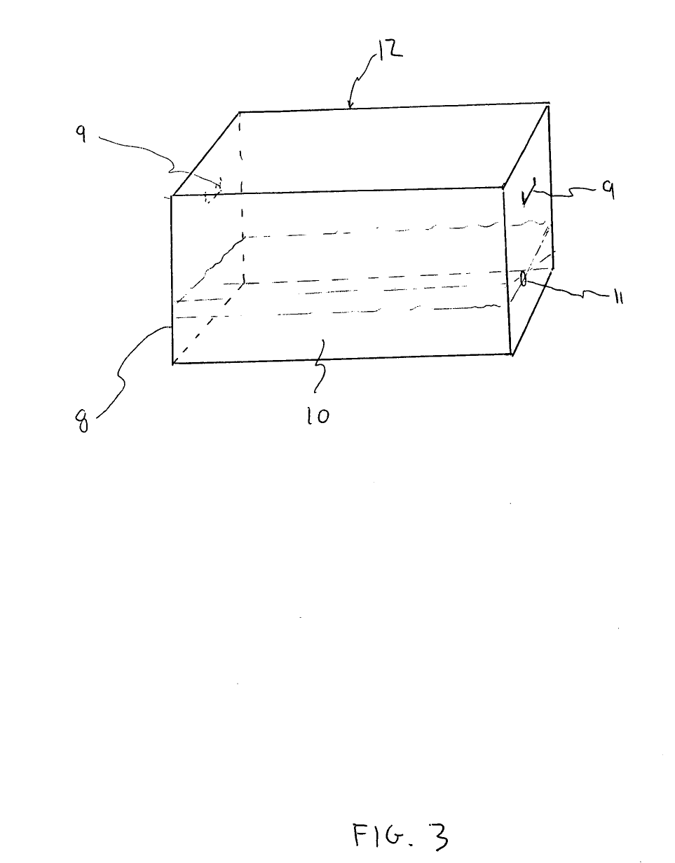

Referring to FIG. 3 handles 9 are disposed on the reservoir 8 to aid in transporting. Fluid 10 is placed in the reservoir 8 and an orifice 11 can provided in said reservoir 8 to prevent too much fluid from collecting in the reservoir 8 if said reservoir is left outside in the rain. Said reservoir 8 is also equipped with a reservoir fastening means 12.

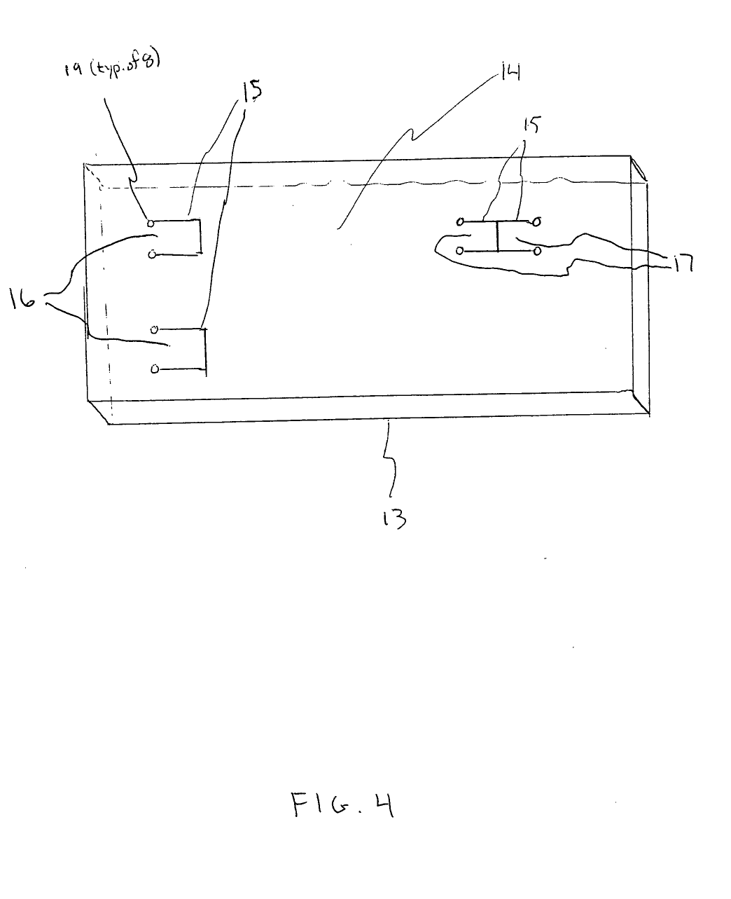

Referring to FIG. 4 the novel lid 14 comes equipped with a lid fastening means 13 to correspond the reservoir fastening means 12 so that the lid 14 can connect to the reservoir 8.

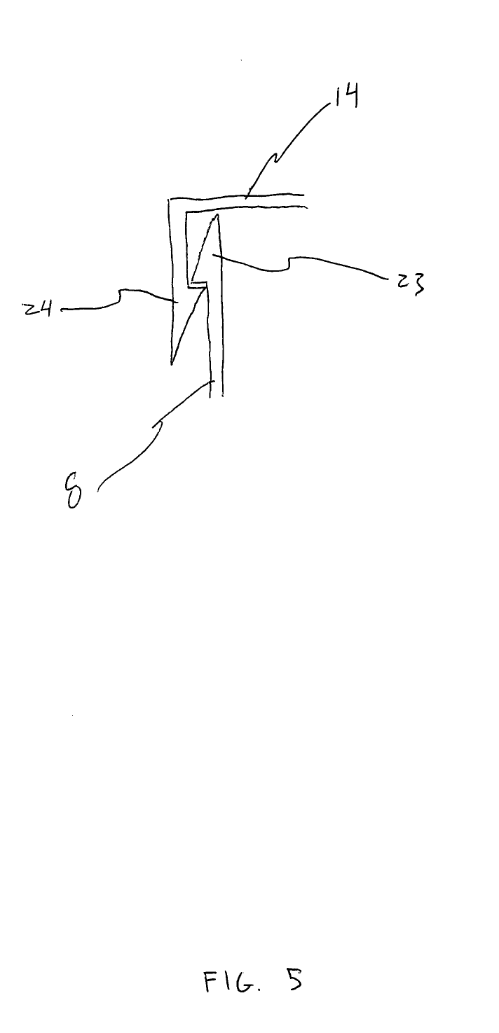

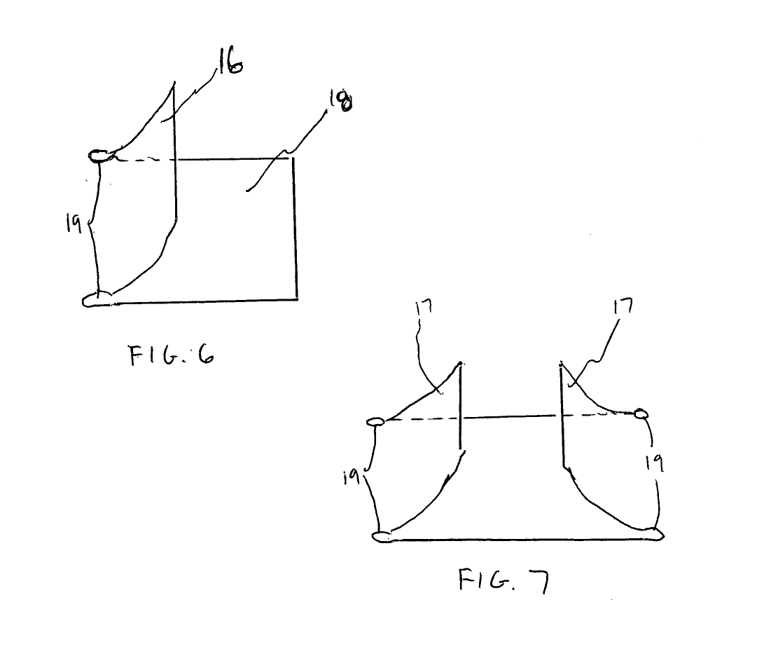

Referring to FIG. 5 said reservoir fastening means 12 is preferably a reservoir continuous barb 23 disposed around the entire perimeter of the reservoir 8. The lid fastening means 13 is preferably a lid continuous barb 24 disposed around the entire perimeter of the lid 14. The lid continuous barb 24 and the reservoir continuous barb 23 mate when the lid 14 is closed as shown in the diagram and since the lid 14 is made of sturdy flexible material, the lid can be removed much like the top to a tub of margarine.

Referring back to FIG. 4, said novel lid 14 has certain cuts 15 through the lid 14 thereby forming flaps 16 or dual-flaps 17. Said lid 14 is composed of a sturdy flexible material, such as plastic to allow the flaps 16 or dual-flaps 17 to bend downward or upward thereby defining apertures 18. Said apertures 18 are sized to fit the planting container 1 so that a planting container 1 may be snugly inserted into the lid 14. It is preferable that flaps 16 are bent upward such that, upon insertion of said planting containers 1, the flap 16 or dual-flaps 17 make contact with the lip 6 thereby preventing the plant container 1 from traveling further down the aperture 18.

Holes 19 should be drilled at the end of said cuts 15 to prevent the lid 14 material from tearing.

When the plant container 1 is removed from the aperture 18, the flap 16 or dual-flap 17 will automatically close the aperture 18 thereby preventing all, or most all, light and any plant debris or other pollutants from fowling the fluid 10. Said automatic closure of the aperture 18 also prevents household pets from drinking the fluid 10.

This invention is best-suited for multiple plant containers 1.

I claim:

1. a planting device comprising:
a reservoir containing fluid;
one or more plant containers wherein each of said plant containers incorporate a wick;
a lid to said reservoir wherein said lid incorporates one or more apertures wherein each of said apertures accommodate one of said plant containers; and
means for closing said aperture when said plant container is removed from said aperture.

2. a planting device comprising:
a reservoir containing fluid;
one or more plant containers wherein each of said plant containers incorporate a wick;
a lid to said reservoir wherein said lid incorporates one or more apertures wherein each of said apertures accommodate one of said plant containers; and
means for automatically closing said aperture when said plant container is removed from said aperture.

3. The planting device in claim 1 wherein said aperture incorporates means for positioning said plant container at a predetermined height.

3. The planting device in claim 2 wherein said aperture incorporates means for positioning said plant container at a predetermined height.
